(19) United States
(12) Patent Application Publication
(10) Pub. No.: US 2026/0093591 A1
(43) Pub. Date: Apr. 2, 2026

(54) ANOMALY DETECTION RESULTING FROM A RESOURCE EVENT INCIDENT

(71) Applicant: BANK OF AMERICA CORPORATION, Charlotte, NC (US)

(72) Inventors: John Lozes, Wilmington, DE (US); Mohammad Saleem Gaziani, Plano, TX (US); Aaron Gee, Palm Coast, FL (US); Aisha Jenkins, Atlanta, GA (US); Tonya Kyra Miller, Charlotte, NC (US); Manonmani Palanichamy, Fort Mill, SC (US); Naresh Kumar Petapalle, Welling (GB); Aravind Singtalur, McKinney, TX (US); Asha Thekkumpurath, Frisco, TX (US); Andrea M. Weisberger, Jacksonville, FL (US)

(73) Assignee: BANK OF AMERICA CORPORATION, Charlotte, NC (US)

(21) Appl. No.: 18/902,286

(22) Filed: Sep. 30, 2024

(51) Int. Cl. G06F 11/30; G06F 11/10

(52) U.S. Cl. CPC G06F 11/3072; G06F 11/1012; G06F 11/3051

(57) ABSTRACT

An application-level determination of anomalies in response to issuance of an incident ticket/report. AI including NLP is implemented to decipher the unstructured freeform data in an incident ticket to positively identify the resource event that caused the incident. Once the resource event has been identified, a resource event tracing record associated with the resource event is analyzed to determine one or more anomalies. Analysis of the resource event tracing record may include comparison of the resource event tracing record to other resource event tracing records having one or more similar attributes to determine differences in recorded metrics, which may indicate anomalies. In response to determining the isolated and/or systemic anomalies, an anomaly report that indicates at least a portion of the determined anomalies is generated, and electronic communication is initiated.

### FIELD OF THE INVENTION

The present invention is generally directed to determining anomalies in computing application or systems and, more specifically, implementing Artificial Intelligence (AI) including Natural Language Processing (NLP) to identify the resource event from the unstructured freeform data within an incident ticket. Once the resource event is identified historical resource event data, such resource event tracing records are analyzed, including comparison amongst resource event tracing records having similar to attributes to the identified resource event to identify the anomaly(s) that led to the incident.

### BACKGROUND

Incident tickets/records are manually created in response to a user experiencing a problem (i.e., incident) while conducting a resource event. The incident ticket includes a freeform dialog/text (i.e., unstructured data) which serves to describe the incident/problem and identifies the user. However, while the freeform dialog may provide insight into which specific resource event led to the incident, the freeform dialog does not positively identify the resource event.

Conventionally, once an incident ticket has been created, manual intervention is required to identify which resource event is associated with an incident and determine the cause of the incident, such as anomalies occurring in one or more of the applications/processes included within the resource event. However, in most instances, numerous sources of information and large volumes of information within such sources prevent the identification of the resource event and determination of the application/process anomalies in an efficient and effective manner. Moreover, if an anomaly is determined to be a systemic anomaly that affects a myriad of users, efficiencies in identifying the anomaly not only negatively impact more users but also potentially impacts the bottom line.

Therefore, a need exists to develop systems, computer-implemented methods, computer program products or the like that serve to effectively and efficiently identifying the resource event that led to a user incident and, once identified, determine the anomalies that occurred within the applications/processes involved in the resource event that likely caused the incident. Specifically, desired systems, methods and the like should be capable of determining isolated or individual anomalies that only affect one specific resource event/user as well as systemic anomalies that affect multiple resource events/users. Effective automated determination of the anomalies will eliminate the guesswork and inaccuracies caused by manual determination. Moreover, efficient automated determination will isolate systematic anomalies proximate to the time of occurrence, thus allowing for the anomalies to be addressed/corrected in a more efficient manner so that their impact can be lessened.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing for efficient and effective determination of application-level anomalies in response to issuance of an incident ticket/report. As previously discussed, incident tickets include unstructured freeform data, such as text entries or the like that serve to explain details surrounding the incident. While the freeform data may provide details of the associated resource event that caused the incident, the freeform data does not positively identify the resource event. As such, the present invention implements Artificial Intelligence (AI) including Natural language Processing (NLP) to decipher the unstructured freeform data and positively identify the resource event that caused the incident.

Once the resource event has been identified, the invention analyzes resource event data, such as a resource event tracing record which includes metrics, error codes and the like for all of the applications required to process the resource event, to subsequent determine one or more anomalies. In specific embodiments of the invention, a resource event tracing record is generated for each resource event by creating a resource event identifier at resource event initiation and collecting resource event tracing data (i.e., metrics and the like) at each application required to process the resource event. The resource event tracing data is associated with the resource event identifier, so that subsequently the resource event tracing data is compiled into a consolidated resource event tracing record tied to the resource event via the resource event identifier.

In specific embodiments of the invention analysis of the resource event tracing record may include comparison of the resource event tracing record to other resource event tracing records having one or more similar attributes (e.g., same time period of occurrence, same processing hardware, same processing location or the like) to determine differences in metrics (e.g., differences in response times, time out times or the like). Such comparisons may result in determination of isolated anomalies (affecting only the identified resource event) or systematic anomalies (affecting multiple resource events).

In response to determining the anomalies (isolated and/or systemic), the present invention generates, and initiates electronic communication of, an anomaly report that indicates at least a portion of the determined anomalies. In specific embodiments of the invention, once the anomalies have been determined they are ranked in terms of the probability of causing the incident. In other specific embodiments of the invention, once the anomalies have been determined a determination is made as to whether the anomaly meets or exceeds a level of importance threshold. In such embodiments of the invention, generation and communication of the anomaly report may be predicated on at least one of the anomalies exceeding the level of importance threshold and, if two or more anomalies exceed the level of importance threshold, listing the anomalies in their respective ranked order of incident-causing probability.

A system for detecting anomalies as a result of a resource event incident defines first embodiments of the invention. The system includes a first memory and one or more first computing processor devices in communication with the first memory. Additionally, the system includes an anomaly detection sub-system comprising Artificial Intelligence (AI) including Natural Language Processing (NLP). The anomaly detection sub-system is stored in the first memory and executable by at least one of the one or more first computing processor devices.

The anomaly detection sub-system is configured to receive an incident ticket related to an incident occurring within at least one first resource event conducted by the use. The incident ticket (i) includes a user identifier associated the user, and (ii) and unstructured freeform information that describes details of the incident. In response to receiving the incident ticket, anomaly detection sub-system is configured to implement the AI including the NLP on the unstructured freeform information to identify the at least one first resource event that is/are associated with the incident.

In response to identifying the at least one first resource event, anomaly detection sub-system is further configured to analyze at least a first resource event tracing record associated with the first resource event to determine at least one of (i) one or more isolated anomalies resulting from the first resource event, and (ii) one or more systemic anomalies resulting from other resource events that are similar to the first resource event. In response to determining the at least one of (i) one or more isolated anomalies and (ii) one or more systemic anomalies, anomaly detection sub-system is further configured to generate, and initiate electronic communication of, an anomaly report that indicates at least one of (a) at least one of the one or more isolated anomalies and (b) at least one of the one or more systemic anomalies associated with the first resource event.

In specific embodiments of the system, the anomaly detection sub-system is further configured to analyze the first resource event tracing record associated with the first resource event to identify at least one of (i) error codes and (ii) exception codes that indicate the one or more isolated anomalies resulting from the first resource event. In other related specific embodiments of the system, the anomaly detection sub-system is further configured to compare the first resource event tracing record to at least one other resource event tracing record, each other resource event tracing record associated with a corresponding second resource event, to determine the one or more isolated anomalies resulting from the first resource event.

In other specific embodiments of the system, the anomaly detection sub-system is further configured to compare the first resource event tracing record to at least one other resource event tracing record, each other resource event tracing record associated with a corresponding second resource event, to determine the one or more systemic anomalies resulting from the other resource events that are similar to the first resource event. In such embodiments of the system, the at least one other resource event tracing record are associated with second resource events occurring prior to the resource event and having at least one of a same (i) occurrence time period (e.g., same hour of the day, same day of the week or the like) (ii) processing hardware (e.g., same server or the like) and (iii) processing location (e.g., same data center or the like) as the first resource event.

In further specific embodiments of the system, the anomaly detection sub-system is further configured to determine whether each of the at least one of (i) one or more isolated anomalies and (ii) one or more systemic anomalies meet or exceed a level of importance threshold. In related embodiments of the system, the anomaly detection sub-system is further configured to generate and initiate electronic communication of the anomaly report that indicates the at least one of (i) one or more isolated anomalies and (ii) one or more systemic anomalies determined to meet or exceed the level of importance threshold. In further related embodiments of the system, the anomaly detection sub-system is further configured to rank the at least one of (i) one or more isolated anomalies and (ii) one or more systemic anomalies based on a probability of causing the incident. In such embodiments of the system, the anomaly detection sub-system is further configured to generate and initiate electronic communication of the anomaly report that indicates, in ranked order, the at least one of (i) one or more isolated anomalies and (ii) one or more systemic anomalies determined to meet or exceed the level of importance threshold.

In other specific embodiments the system includes a second memory and one or more second computing processor devices in communication with the second memory. Further, the system includes a resource event tracing sub-system that is stored in the second memory and executable by at least one of the one or more second computing processor devices. The resource event tracing sub-system is configured to, for each resource event occurring within an enterprise, assign a unique identifier to a corresponding resource event in response to initiating the corresponding resource event. The resource event tracing sub-system is further configured, to in response to processing each of the resource events to completion via a plurality of resource event-related applications, (i) capture and record resource event tracing data at each of the plurality of resource event-related applications, and (ii) associate each recorded resource event tracing data with the corresponding unique identifier assigned to the corresponding resource event. Further, the resource event tracing sub-system is configured compile the recorded resource event tracing data to form a resource event tracing record for the corresponding resource event and store the resource event tracing record in a record repository. In related embodiments of the system the anomaly detection sub-system is further configured to: implement the AI including the NLP on the unstructured freeform information to identify at least a resource event type for the resource event, and identify the resource event by accessing the record repository in the resource event tracing sub-system to identify the first resource event tracing record from amongst a plurality resource event tracing records in the record repository, such that the first resource event tracing record is associated with the first resource event and identified based at least on the user identifier and the resource event type.

A computer-implemented method for detecting anomalies as a result of a resource event incident defines second embodiments of the invention. The computer-implemented method is executed by one or more computing processor devices. The computer-implemented method includes receiving an incident ticket related to an incident occurring within a first resource event conducted by the user. The incident ticket (i) includes a user identifier associated the user, and (ii) and unstructured freeform information that describes details of the incident. The method further includes implementing Artificial Intelligence (AI) including Natural Language Processing (NLP) on the unstructured freeform information to identify the first resource event associated with the incident. In response to identifying the first resource event, the computer-implemented method includes analyzing at least a first resource event tracing record associated with the first resource event to determine at least one of (i) one or more isolated anomalies resulting from the first resource event, and (ii) one or more systemic anomalies resulting from other resource events that are similar to the first resource event. In response to determining the at least one of (i) one or more isolated anomalies and (ii) one or more systemic anomalies, the computer-implemented method includes generating, and initiating electronic communication of, an anomaly report that indicates at least one of (a) at least one of the one or more isolated anomalies and (b) at least one of the one or more systemic anomalies associated with the first resource event.

In specific embodiments of the computer-implemented method, analyzing further includes analyzing the first resource event tracing record associated with the first resource event to identify at least one of (i) error codes and (ii) exception codes that indicate the one or more isolated anomalies resulting from the first resource event. In related embodiments of the computer-implemented method, analyzing further includes comparing the first resource event tracing record to at least one other resource event tracing record, each other resource event tracing record associated with a corresponding second resource event, to determine at least one of (i) the one or more isolated anomalies resulting from the first resource event and (ii) the one or more systemic anomalies resulting from the other resource events that are similar to the first resource event.

In further specific embodiments the computer-implemented method includes comprising determining whether each of the at least one of (i) one or more isolated anomalies and (ii) one or more systemic anomalies meet or exceed a level of importance threshold. In such embodiments of the computer-implemented method, generating further includes generating, and initiating electronic communication of, the anomaly report that indicates the at least one of (i) one or more isolated anomalies and (ii) one or more systemic anomalies determined to meet or exceed the level of importance threshold. In related embodiments the computer-implemented method further includes ranking the at least one of (i) one or more isolated anomalies and (ii) one or more systemic anomalies based on a probability of causing the incident. In such embodiments of the computer-implemented method, generating further include generating, and initiating electronic communication of, the anomaly report that indicates, in ranked order, the at least one of (i) one or more isolated anomalies and (ii) one or more systemic anomalies determined to meet or exceed the level of importance threshold.

A computer program product including a non-transitory computer-readable medium defines third embodiments of the invention. The non-transitory computer-readable medium includes a set of codes for causing one or more computing devices to receive an incident ticket related to an incident occurring within a first resource event conducted by the user. The incident ticket (i) includes a user identifier associated the user, and (ii) and unstructured freeform information that describes details of the incident. The computer-readable medium additionally includes a set of codes for causing the computing device(s) to implement Artificial Intelligence (AI) including Natural Language Processing (NLP) on the unstructured freeform information to identify the first resource event associated with the incident. In response to identifying the first resource event, the computer-readable medium additionally includes a set of codes for causing the computing device(s) to analyze at least a first resource event tracing record associated with the first resource event to determine at least one of (i) one or more isolated anomalies resulting from the first resource event, and (ii) one or more systemic anomalies resulting from other resource events that are similar to the first resource event. In response to determining the at least one of (i) one or more isolated anomalies and (ii) one or more systemic anomalies, the computer-readable medium additionally includes a set of codes for causing the computing device(s) to generate, and initiate electronic communication of, an anomaly report that indicates at least one of (a) at least one of the one or more isolated anomalies and (b) at least one of the one or more systemic anomalies associated with the first resource event.

In specific embodiments of the computer program product, the set of codes for causing the one or more computing devices to analyze are further configured to cause the one or more computing devices to analyze the first resource event tracing record associated with the first resource event to identify at least one of (i) error codes and (ii) exception codes that indicate the one or more isolated anomalies resulting from the first resource event. In other related specific embodiments of the computer program product, the set of codes for causing the one or more computing devices to analyze are further configured to cause the one or more computing devices to compare the first resource event tracing record to at least one other resource event tracing record, each other resource event tracing record associated with a corresponding second resource event, to determine at least one of (i) the one or more isolated anomalies resulting from the first resource event and (ii) the one or more systemic anomalies resulting from the other resource events that are similar to the first resource event.

In further specific embodiments of the computer program product, the sets of codes further include sets of codes for causing the one or more computing devices to rank the at least one of (i) one or more isolated anomalies and (ii) one or more systemic anomalies based on a probability of causing the incident further comprising determining whether each of the at least one of (i) one or more isolated anomalies and (ii) one or more systemic anomalies meet or exceed a level of importance threshold and determine whether each of the at least one of (i) one or more isolated anomalies and (ii) one or more systemic anomalies meet or exceed a level of importance threshold. In such embodiments of the computer program product, the set of codes for causing the one or more computing devices to generate are further configured to cause the one or more computing devices to generate, and initiate electronic communication of, the anomaly report that indicates, in ranked order, the at least one of (i) one or more isolated anomalies and (ii) one or more systemic anomalies determined to meet or exceed the level of importance threshold.

Thus, as described in detail above, present embodiments of the invention include systems, methods, computer program products and/or the like that provide for application-level determination of anomalies in response to issuance of an incident ticket/report. AI including NLP is implemented to decipher the unstructured freeform data in an incident ticket to positively identify the resource event that caused the incident. Once the resource event has been identified, a resource event tracing record associated with the resource event is analyzed to determine one or more anomalies. Analysis of the resource event tracing record may include comparison of the resource event tracing record to other resource event tracing records having one or more similar attributes (e.g., same time period of occurrence, same processing hardware, same processing location or the like) to determine differences in metrics (e.g., differences in response times, time out times or the like), which may indicate anomalies. In response to determining the isolated and/or systemic anomalies, an anomaly report that indicates at least a portion of the determined anomalies is generated, and electronic communication is initiated.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic/block of a system for detecting anomalies associated with a resource event incident, in accordance with embodiments of the present invention;

FIG. 2 is a schematic/block diagram of an alternate system for detecting anomalies associated with a resource event incident, in accordance with embodiments of the present invention;

FIG. 3 is a block diagram of a computing platform storing an anomaly detection sub-system, in accordance with embodiments of present invention;

FIG. 4 is a flow diagram of a method for detecting anomalies associated with a resource event incident and generating an anomaly report, in accordance with embodiments of the present invention; and

FIG. 5 is a flow diagram of a method for detecting anomalies associated with a resource event incident, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product, or a combination of the foregoing. Accordingly, embodiments of the present invention may take the form of an entirely hardware embodiment, an entirely software embodiment (including firmware, resident software, micro-code, a.), or an embodiment combining software and hardware aspects that may be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for conducting operations of embodiments of the present invention may be written in an object oriented, scripted, or unscripted programming language such as JAVA, PERL, SMALLTALK, C++, PYTHON, or the like. However, the computer program code/computer-readable instructions for conducting operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to conduct an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

“Computing platform” or “computing device” as used herein refers to a networked computing device within the computing system. The computing platform includes a processor, a non-transitory storage medium (i.e., memory), a communications device, and a display. The computing platform may be configured to support user logins and inputs from any combination of similar or disparate devices. Accordingly, the computing platform includes servers, personal desktop computer, laptop computers, mobile computing devices and the like.

Thus, systems, apparatus, and methods are described in detail below that providing for determination of application-level anomalies in response to issuance of an incident ticket/report. As previously discussed, incident tickets include unstructured freeform data, such as text entries or the like that serve to explain details surrounding the incident. While the freeform data may provide details of the associated resource event that caused the incident, the freeform data does not positively identify the resource event. As such, the present invention implements Artificial Intelligence (AI) including Natural language Processing (NLP) to decipher the unstructured freeform data and positively identify the resource event that caused the incident.

Once the resource event has been identified, the invention analyzes resource event data, such as a resource event tracing record which includes metrics, error codes and the like for all of the applications required to process the resource event, to subsequent determine one or more anomalies. In specific embodiments of the invention, a resource event tracing record is generated for each resource event by creating a resource event identifier at resource event initiation and collecting resource event tracing data (i.e., metrics and the like) at each application required to process the resource event. The resource event tracing data is associated with the resource event identifier, so that subsequently the resource event tracing data is compiled into a consolidated resource event tracing record tied to the resource event via the resource event identifier.

In specific embodiments of the invention analysis of the resource event tracing record may include comparison of the resource event tracing record to other resource event tracing records having one or more similar attributes (e.g., same time period of occurrence, same processing hardware, same processing location or the like) to determine differences in metrics (e.g., differences in response times, time out times or the like). Such comparisons may result in determination of isolated anomalies (affecting only the identified resource event) or systematic anomalies (affecting multiple resource events).

In response to determining the anomalies (isolated and/or systemic), the present invention generates, and initiates electronic communication of, an anomaly report that indicates at least a portion of the determined anomalies. In specific embodiments of the invention, once the anomalies have been determined they are ranked in terms of the probability of causing the incident. In other specific embodiments of the invention, once the anomalies have been determined a determination is made as to whether the anomaly meets or exceeds a level of importance threshold. In such embodiments of the invention, generation and communication of the anomaly report may be predicated on at least one of the anomalies exceeding the level of importance threshold and, if two or more anomalies exceed the level of importance threshold, listing the anomalies in their respective ranked order of incident-causing probability.

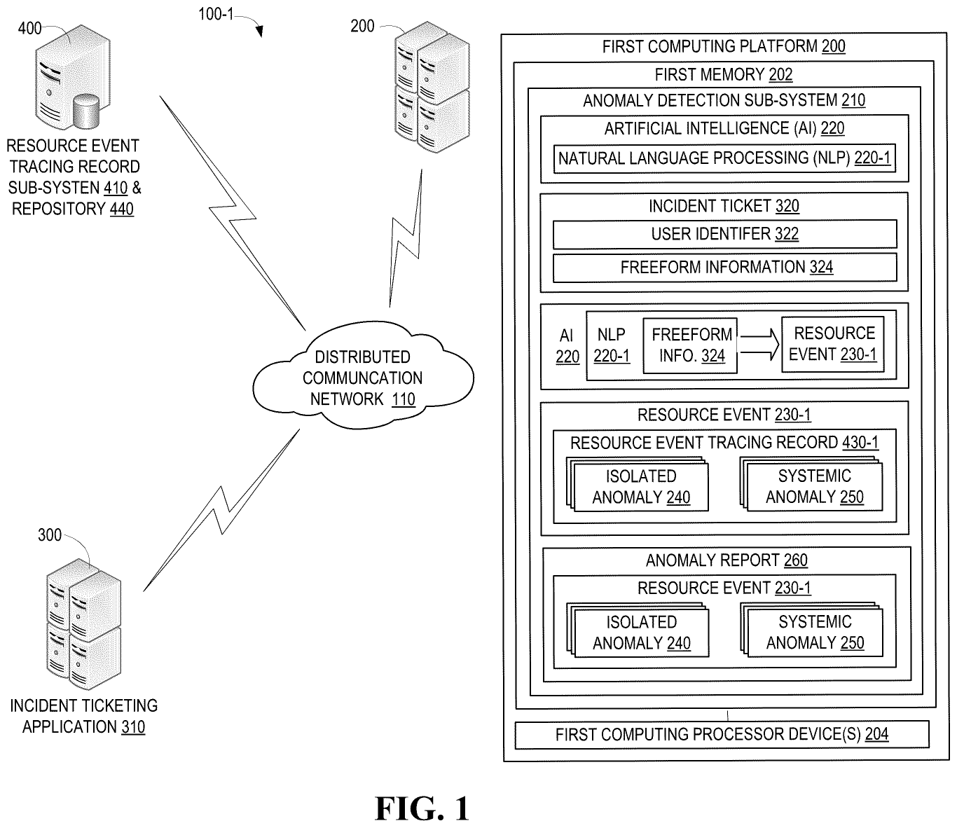

Referring to FIG. 1, a schematic/block is presented of a system 100-1 for determining/detecting anomalies related to a resource event incident, in accordance with embodiments of the present invention. A resource event as used herein is any computer-related event associated with resources (e.g., financial resources or the like). For example, a resource event may be a resource exchange (e.g., payment), a resource transfer (e.g., account-to-account), resource account initiation (e.g., opening an account), a resource balance inquiry or any activity performed with a resource processing entity (e.g., financial institution or the like) website (e.g., online banking) or application (i.e., mobile app). A resource event incident is any problem encountered by a user when conducting the resource event. In the present invention, the user reports the problem to the associated entity (e.g., financial institution or the like) and an incident ticket is generated/opened to investigate the cause of the incident and resolve the incident to ensure that the incident will be an on-going problem. Anomalies as used herein are noted differences within the processing of the resource event, such as the occurrence of error codes, exception codes, time outs, abnormal response times, abnormal volume of resource events, abnormal dependent service times and the like. Such anomalies may subsequently be determined to be the cause of the incident.

The system 100-1 is implemented amongst a distributed communication network 110, which may include the Internet, one or more intranets, cellular network(s) or the like. The system includes first computing platform 200 which may comprise an application server(s) or the like. First computing platform 200 includes first memory 202 and one or more first computing processor devices 204 that are in communication with first memory 202. First memory 202 stores anomaly detection sub-system 210, which is executable by at least one of the first computing processor device(s) 204. Anomaly detection sub-system 210 includes Artificial Intelligence (AI) 220, which includes, but is not limited to, Natural Language Processing (NLP).

Anomaly detection sub-system 210 is configured to receive an incident ticket 320, otherwise referred to as an incident ticket, which is received from an incident ticketing application 310 executing on a third computing platform 300, such as an application server or the like. Incident ticket 320 is related to an incident, which occurred within or is otherwise related to a first resource event which was conducted by the user (i.e., incident party). The incident ticket 320 includes a user identifier 320 (e.g., name, resource account number or the like) and freeform information 324 which provides details concerning the incident. The freeform information 324 is unstructured textual data inputted by an incident ticketing entity or the user. It should be noted that while the freeform information 324 may provide details (e.g., platform, time, type of resource event) associated with the resource event (or resource events) that led to the incident, the freeform information 324 does not positively identify the resource event. Positive identification of the resource event as used herein is identification that would allow the resource event to be looked-up/identified within a historical resource event database.

In response to receiving the incident ticket, anomaly detection sub-system 210 is configured to implement the AI 220, specifically, but not necessarily limited to, the NLP 220-1 on the unstructured freeform information, and using the used identifier 322, to positively identify the resource event(s) 230-1 associated with the incident. In this regard, the anomaly detection sub-system 210 may implement the NLP to determine relevant details associated with the resource events, such as resource event type, date, time and the like. The sub-system then uses these relevant details, along with the user identifier 322 to positively identify the resource event(s) within a resource event tracing record repository 440 stored within a second computing platform 400, such as a database server or the like.

In response to identifying the resource event(s) 230-1, anomaly detection sub-system 210 is configured to analyze at least a first resource event tracing record 430-1 associated with the resource event 230-1 to determine at least one of (i) one or more isolated anomalies 240 resulting the resource event 230-1 and (ii) one or more systemic anomalies 250 resulting from other resource events 230 that are similar to the resource event 230-1. Isolated anomalies are individual anomalies that only affect the resource event in question. Systematic anomalies not only affect the resource event 230-1 but also other resource events that are similar to the resource event 230-1 in question (e.g., occurred/occurring within similar/same time period, using same resource event hardware (e.g., server(s)), using same physical location (e.g., data center) or the like).

In response to determining the at least one of (i) one or more isolated anomalies 240 and (ii) one or more systemic anomalies 250, the anomaly detection sub-system 210 is further configured to generate, and initiate electronic communication of, an anomaly report 260 that indicates at least one of (a) at least one of the one or more isolated anomalies 240 and (b) at least one of the one or more systemic anomalies 250 associated with the resource event(s) 230-1.

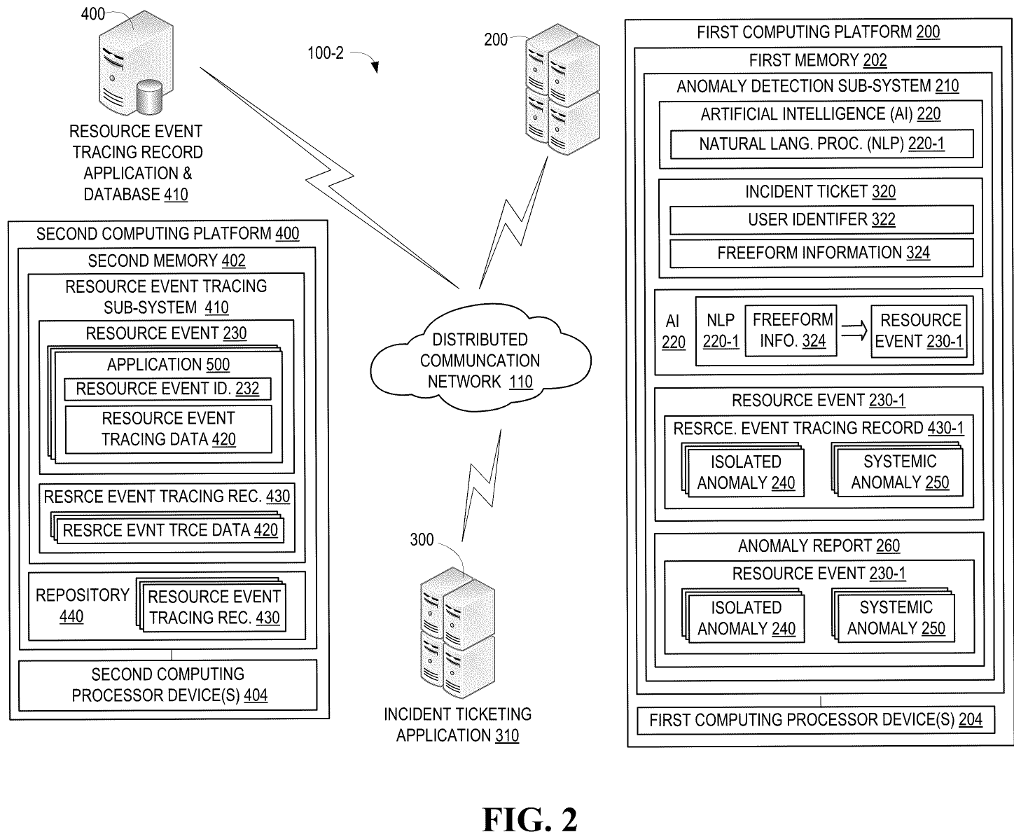

Referring to FIG. 2, a schematic/block is presented of an alternate system 100-2 for determining/detecting anomalies, in accordance with embodiments of the present invention. System 100-2 includes the same first computing platform 200 and, thus, anomaly detection sub-system 210 as described in relation to FIG. 1. As such, for the sake of brevity, first computing platform 200 and anomaly detection sub-system will not be discussed in relation to FIG. 2.

System 100-2 includes second computing platform 400, which may comprise a database server(s), an application server(s) or the like. Second computing platform 400 includes second memory 402 and one or more second computing processor devices 404 that are in communication with second memory 402. Second memory 402 stores resource event tracing sub-system 410, which is executable by at least one of the second computing processor device(s) 404. Resource event tracing sub-system 210 is configured to provide end-to-end tracing data for a resource event. In this regard, resource event tracing sub-system 210 is configured to assign a unique resource event identifier 232 for each resource event 230 at the inception of the resource event 230. Each resource event 230 is processed by at least one, and typically multiple different, applications 500 in order for the resource event 230 to be processed to completion. Resource event tracing sub-system 410 is configured to communicate the resource event identifier 232 to each application 500 responsible for processing the corresponding resource event 230. In response to performing the requisite processing, each application 500 records resource event tracing data 420, such as metrics (e.g., error codes, exception codes, response times and the like) and associates the metrics with the resource event identifier 232. Subsequently, the resource event tracing data 420 from each application 500 is compiled into a resource event tracing record 430 for the corresponding resource event 230 and each resource event tracing record 430 is stored in repository/database 440.

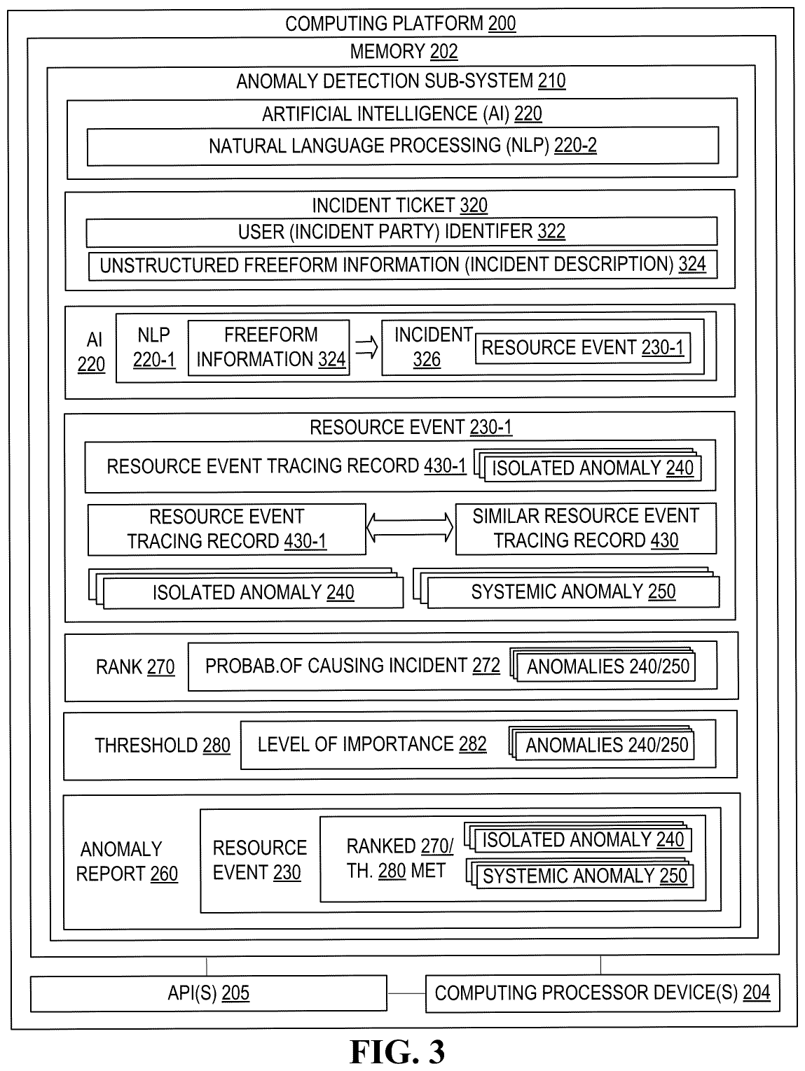

In accordance with the present invention, the corpus of resource event tracing record 430 may be accessed to positively identify the resource event(s) 230-1 associated with the identity. As discussed in greater detail in relation to FIG. 3, infra., once the resource event(s) 230-1 has been positively identified, at least the resource event tracing record(s) 430-1 associated with the resource event(s) 230-1 in question is analyzed to determine isolated anomaly(s) 240 and/or systematic anomalies 250.

Referring to FIG. 3, a block diagram is depicted of computing platform 200 highlighting various alternate embodiments of the system shown and described in relation to FIG. 1, in accordance with embodiments of the present invention. Computing platform 200 may comprise one or multiple computing devices, such as application servers or the like or the like. As previously discussed in relation to FIG. 1, computing platform 200 includes memory 202, which may comprise volatile and/or non-volatile memory, such as read-only memory (ROM) and/or random-access memory (RAM), EPROM, EEPROM, flash cards, or any memory common to computing platforms. Moreover, memory 202 may comprise cloud storage, such as provided by a cloud storage service and/or a cloud connection service.

Further, computing platform 200 includes one or more computing processor devices 204, which may be an application-specific integrated circuit (“ASIC”), or other chipset, logic circuit, or other data processing device. Computing processor device(s) 204 may execute one or more application programming interface (APIs) 205 that interface with any resident programs, such as anomaly detection sub-system 210 or the like, stored in memory 202 of computing platform 200 and any external programs. Computing platform 200 includes various processing sub-systems (not shown in FIG. 3) embodied in hardware, firmware, software, and combinations thereof, that enable the functionality of computing platform 200 and the operability of computing platform 200 on a distributed communication network, such as distributed communication network 110 shown in FIG. 1. For example, processing sub-systems allow for initiating and maintaining communications and exchanging data with other networked devices. For the disclosed aspects, processing sub-systems of computing platform 200 includes any processing sub-system portion used in conjunction with anomaly detection sub-system 210 and engines, tools, routines, sub-routines, applications, sub-applications, sub-modules thereof.

In specific embodiments of the present invention, computing platform 200 additionally includes a communications module (not shown in FIG. 3) embodied in hardware, firmware, software, and combinations thereof, that enables electronic communications between components of computing platform 200 and other networks and network devices. Thus, communication module includes the requisite hardware, firmware, software and/or combinations thereof for establishing and maintaining a network communication connection with one or more devices and/or networks.

As previously discussed in relation to FIG. 1, memory 202 stores anomaly detection sub-system 210 that is executable by one or more of the computing processor device(s) 204. anomaly detection sub-system 210 includes Artificial Intelligence (AI) 220, specifically, but not limited to, Natural Language Processing (NLP).

As previously discussed in relation to FIG. 1, anomaly detection sub-system 210 is configured to receive an incident ticket 320, otherwise referred to as an incident ticket, which is received from an incident ticketing application 310 executing on a third computing platform 300, such as an application server or the like. Incident ticket 320 is related to an incident, which occurred within or is otherwise related to a first resource event which was conducted by the user (i.e., incident party). The incident ticket 320 includes a user identifier 320 (e.g., name, resource account number or the like) and freeform information 324 which provides details concerning the incident. The freeform information 324 is unstructured textual data inputted by an incident ticketing entity or the user. It should be noted that while the freeform information 324 may provide details (e.g., platform on which incident occurred, time, type of resource event) associated with the resource event (or resource events) that led to the incident, the freeform information 324 does not positively identify the resource event. Positive identification of the resource event as used herein is identification that would allow the resource event to be looked-up/identified within a historical resource event database.

In response to receiving the incident ticket, anomaly detection sub-system 210 is configured to implement the AI 220, specifically, but not necessarily limited to, the NLP 220-1 on the unstructured freeform information, and using the used identifier 322, to positively identify the resource event(s) 230-1 associated with the incident. In this regard, the anomaly detection sub-system 210 may implement the NLP 220-1 to determine relevant details associated with the resource events, such as resource event type, date, time and the like. The sub-system then uses these relevant details, along with the user identifier 322 to positively identify the resource event(s) within a resource event tracing record repository 440 stored within a second computing platform 400, such as a database server or the like. In this regard, the user identifier is used to locate resource event tracing records 430 associated with the user and that meet other criteria defined by relevant details in the freeform information 324. Further, the resource event 230-1 may be identified based on a resource event tracing records 430-1 including an error code, exception code, abnormal response time/time out or the like.

In response to identifying the resource event(s) 230-1, anomaly detection sub-system 210 is configured to analyze the first resource event tracing record 430-1 associated with the resource event 230-1 to determine one or more isolated anomalies 240 resulting the resource event 230-1. For example, the first resource event tracing record 430-1, which identified the resource event 230-1 may include error code(s), exception code(s), timeouts or the like. Thus, the same means by which the resource event 230-1 was positively identified may serve as the isolated anomalies 240. In other embodiments of the system, anomaly detection sub-system 210 is configured to compare the first resource event tracing record 430-1 to other similar resource event tracing records 420 (e.g., similar with respect to (i) time of day/week or the like at which resource event occurred, (ii) resource event processing hardware (e.g., server(s) or the like), (iii) resource event physical location (e.g., data center) or the like). The comparison may result in determination of determinations of isolated anomalies 240 (i.e., only affecting the resource event in question) or systemic anomalies 250 (i.e., affecting multiple resource events).

In response to determining the at least one of (i) one or more isolated anomalies 240 and (ii) one or more systemic anomalies 250, the anomaly detection sub-system 210 is further configured to rank the identified isolated anomalies 240 and/or systemic anomalies 250 in terms of the probability that the anomaly caused the incident. The isolated anomalies 240 and systemic anomalies 250 may be ranked individually or, in other embodiments of the system, one composite ranking may be determined.

In response to determining the at least one of (i) one or more isolated anomalies 240 and (ii) one or more systemic anomalies 250, the anomaly detection sub-system 210 is further configured to compare the isolated anomalies 240 and/or systemic anomalies 250 to a level of importance 282 threshold 280. Each specific anomaly type will have a corresponding threshold 280 as defined by business rules. In other embodiments of the invention, machine learning techniques may be implemented to determine level of importance 282 thresholds 280. Comparison of the anomalies 240/250 to level of importance 282 thresholds 280 is conducted so as to eliminate reporting of low importance anomalies.

As previously discussed in relation to FIG. 1, in response to determining the at least one of (i) one or more isolated anomalies 240 and (ii) one or more systemic anomalies 250, the anomaly detection sub-system 210 is further configured generate, and initiate electronic communication of, an anomaly report 260 that indicates at least one of (a) at least one of the one or more isolated anomalies 240 and (b) at least one of the one or more systemic anomalies 250 associated with the resource event(s) 230-1. In specific embodiments of the invention, the (a) at least one of the one or more isolated anomalies 240 and (b) at least one of the one or more systemic anomalies 250 are those anomalies that have been determined to meet or exceed the level of importance 282 threshold 280. Moreover, in other specific embodiments of the invention, the (a) at least one of the one or more isolated anomalies 240 and (b) at least one of the one or more systemic anomalies 250 presented in the anomaly report are presented in their ranked order (i.e., ranked in terms of probability of causing the incident).

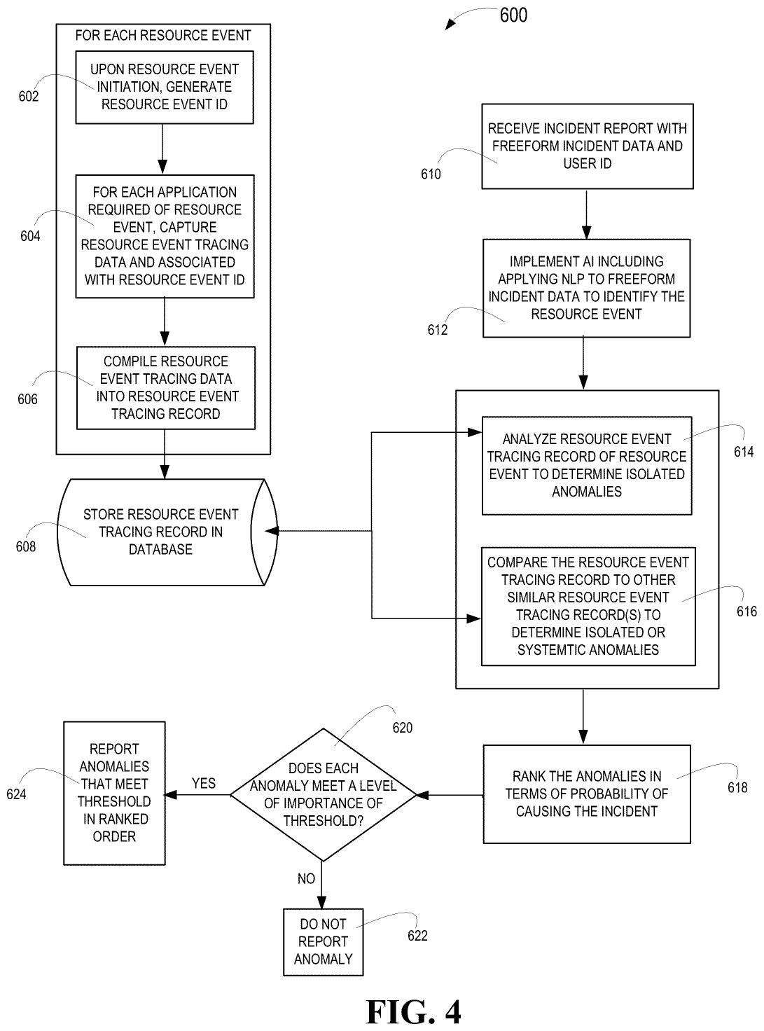

Referring to FIG. 4, a flow diagram is presented of a method 600 for detecting/determining anomalies as a result of a resource event incident, in accordance with embodiments of the present invention. As a precursor to incident initiation, at Event 602, for each resource event occurring within an enterprise, a resource event identifier (e.g., globally unique alpha-numeric identifier or the like) is generated upon onset/initiation of the resource event. At Event 604, the unique identifier is communicated to each application required to process a corresponding resource event and resource event tracing data/metrics (i.e., error codes, exception codes, time outs, response times and the like) are captured at each application and associated with the unique resource event identifier. Once all of the applications have been completed (i.e., the resource event is processed to completion, at Event 606, the resource event tracing data/metrics from all of the applications is compiled into a single comprehensive resource event tracing record and, in response, at Event 608, the resource event tracing records are stored in a repository/database.

Subsequently, at Event 610 an incident ticket/report is received that includes freeform incident data (i.e., unstructured text data) and a user/incident party identifier (e.g., name, resource account number or the like). As previously discussed, the freeform incident data includes data related to the resource event(s) that caused the incident but does not positively identify the resource event (i.e., does not provide for identification of the associated resource event tracing record or the resource event identifier generated by the tracing system). In response to receiving the incident ticket, at Event 612, Artificial Intelligence (AI) including, but not limited to, Natural language Processing (NLP) is applied to the freeform incident data and used along with the user identifier to positively identify the resource event. In specific embodiments of the methos, positive identification of the resource event may involve searching the resource event tracing records to determine which record matches the relevant details found in the freeform data.

In response to identifying the resource event, at Event 614, the resource event tracing database is accessed and the corresponding resource even tracing record associated with the resource event is analyzed to determine isolated anomalies (e.g., error codes, exception codes, time outs and the like). In addition, at Event 616, the resource event tracing database is accessed and other similar resource event tracing records (e.g., same time period, same processing hardware, same physical location and/or the like) are compared to the corresponding resource event tracing record to determine isolated and/or systemic anomalies (e.g., widespread delays in response times or the like).

In response to determining isolated and/or systemic anomalies, at Event 618, the anomalies are ranked in terms of the probability of causing the incident. Isolated and systemic anomalies may be ranked separately and/or included in one comprehensive ranking. While the flow diagram of FIG. 4 depicts the occurrence of the ranking prior to application of a level of importance threshold (i.e., Decision 620), in other embodiments of the invention, the ranking may occur after the application of the level of importance threshold (i.e., prior to generating and initiating communication of the anomaly report (Event 624)).

At Decision 620, the anomalies are compared to a level of importance threshold to determine whether or not the anomalies meet or exceed a requisite level of importance for reporting. In this regard, business rules and/or machine learning techniques are implemented to determine whether or not the anomalies meet or exceed predefined level of importance thresholds. If a determination is made that one or more of the anomalies do not meet a corresponding level of importance threshold, at Event 622, those anomalies are omitted from subsequent anomaly reporting. If a determination is made that one or more of the anomalies do meet the corresponding level of importance threshold, at Event 624, an anomaly report is generated that lists the anomalies determined to meet/exceed their corresponding level of importance in ranked order and communication of the anomaly report is initiated to one or more parties of interest.

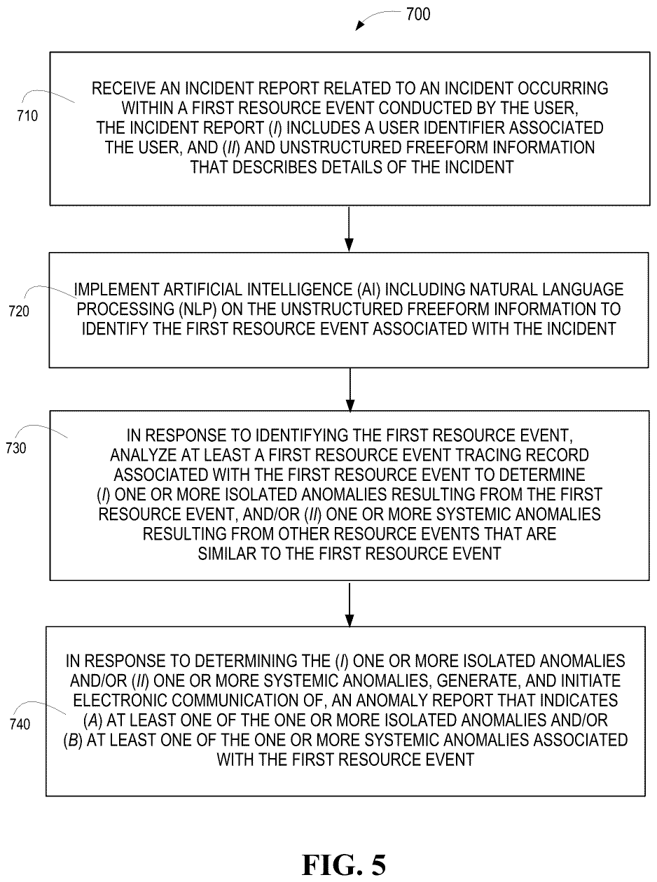

Referring to FIG. 5, a flow diagram is presented of a method 700 for detecting/determining anomalies based on a resource event incident, in accordance with embodiments of the present invention. At Event 710, an incident ticket/report is received. The incident ticket is related to an incident associated with one or more resource events conducted by a user. The incident ticket includes a user identifier associated with the user and freeform/unstructured data that describes relevant details of the incident. It should be noted that while the relevant details are related to the one or more resource events, the incident ticket and, specifically, the freeform data does not positively identify the resource event(s) (i.e., does not provide for the resource event(s) to be identified with a historical tracing database or the like).

In response to receiving the incident ticket, at Event 720, Artificial Intelligence (AI) including Natural Language Processing (NLP) are implemented/applied to the freeform data to positively identify the resource event(s) associated with the incident. Such identification may include using the relevant details in the freeform data and the user identifier to search a historical resource event database, such as a resource event tracing database or the like.

In response to positively identifying the resource event(s), at Event 730, a resource event tracing record(s) associated with the resource event(s) is/are analyzed to determine isolated anomaly(s) resulting from the resource event(s) and/or systemic anomalies resulting from the resource event(s) and other similar resource events. In specific embodiments of the method, analysis includes comparing the resource event tracing record(s) associated with the resource event(s) to other similar resource event tracing record(s) associated with the other similar resource event(s) (e.g., same/similar time period, processing hardware, processing location and the like) to determine isolated or systemic anomalies.

In response to determining isolated and/or systemic anomalies, at Event 740, an anomaly report is generated and electronic communication of the anomaly is initiated. The anomaly report includes a listing, in some embodiments ranked by probability of causing the incident, of the isolated and/or systemic anomalies. In specific embodiments of the method, the anomalies listed with have previously subjected to a level of importance threshold to ensure that the anomalies in the list have met their requisite level of importance (i.e., are not merely noise).

Thus, as described in detail above, present embodiments of the invention include systems, methods, computer program products and/or the like provide for application-level determination of anomalies in response to issuance of an incident ticket/report. AI including NLP is implemented to decipher the unstructured freeform data in an incident ticket to positively identify the resource event that caused the incident. Once the resource event has been identified, a resource event tracing record associated with the resource event is analyzed to determine one or more anomalies. Analysis of the resource event tracing record may include comparison of the resource event tracing record to other resource event tracing records having one or more similar attributes (e.g., same time period of occurrence, same processing hardware, same processing location or the like) to determine differences in metrics (e.g., differences in response times, time out times or the like), which may indicate anomalies. In response to determining the isolated and/or systemic anomalies, an anomaly report that indicates at least a portion of the determined anomalies is generated, and electronic communication is initiated.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for detecting anomalies as a result of a resource event incident, the system comprising:
a first memory;
one or more first computing processor devices in communication with the first memory; and
an anomaly detection sub-system comprising Artificial Intelligence (AI) including Natural Language Processing (NLP) that is stored in the first memory, executable by at least one of the one or more first computing processor devices and configured to:
receive an incident ticket related to an incident occurring within a first resource event conducted by a user, wherein the incident ticket (i) includes a user identifier associated with the user, and (ii) and unstructured freeform information that describes details of the incident,
implement the AI including the NLP on the unstructured freeform information to identify the first resource event associated with the incident,
in response to identifying the first resource event, access a compiled first resource event tracing record associated with the first resource event, the first resource event tracing record comprising machine-generated resource event tracing data collected across a plurality of resource event-related applications and compiled into a consolidated tracing record,
analyze the compiled first resource event tracing record, including the machine-generated resource event tracing data to determine at least one of (i) one or more isolated anomalies resulting from the first resource event and (ii) one or more systemic anomalies resulting from other resource events that are similar to the first resource event, and
in response to determining the at least one of (i) one or more isolated anomalies based on analysis of the compiled first resource event tracing record, and (ii) one or more systemic anomalies, generate and initiate electronic communication of an anomaly report that indicates at least one of (a) at least one of the one or more isolated anomalies and (b) at least one of the one or more systemic anomalies associated with the first resource event.

2. The system of claim 1, wherein the anomaly detection sub-system is further configured to:
analyze the first resource event tracing record associated with the first resource event to identify at least one of (i) error codes and (ii) exception codes that indicate the one or more isolated anomalies resulting from the first resource event.

3. The system of claim 1, wherein the anomaly detection sub-system is further configured to:
compare the first resource event tracing record to at least one other resource event tracing record, each other resource event tracing record associated with a corresponding second resource event, to determine the one or more isolated anomalies resulting from the first resource event.

4. The system of claim 1, wherein the anomaly detection sub-system is further configured to:
compare the first resource event tracing record to at least one other resource event tracing record, each other resource event tracing record associated with a corresponding second resource event, to determine the one or more systemic anomalies resulting from the other resource events that are similar to the first resource event.

5. The system of claim 4, wherein the anomaly detection sub-system is further configured to:
compare the first resource event tracing record to at least one other resource event tracing records, wherein the at least one other resource event tracing record are associated with second resource events occurring prior to the resource event and having at least one of a same (i) occurrence time period, (ii) processing hardware and (iii) processing location as the first resource event.

6. The system of claim 1, wherein the anomaly detection sub-system is further configured to:
determine whether each of the at least one of (i) one or more isolated anomalies and (ii) one or more systemic anomalies meet or exceed a level of importance threshold.

7. The system of claim 6, wherein the anomaly detection sub-system is further configured to:
generate and initiate electronic communication of the anomaly report that indicates the at least one of (i) one or more isolated anomalies and (ii) one or more systemic anomalies determined to meet or exceed the level of importance threshold.

8. The system of claim 7, wherein the anomaly detection sub-system is further configured to:
rank the at least one of (i) one or more isolated anomalies and (ii) one or more systemic anomalies based on a probability of causing the incident.

9. The system of claim 8, wherein the anomaly detection sub-system is further configured to generate and initiate electronic communication of the anomaly report that indicates, in ranked order, the at least one of (i) one or more isolated anomalies and (ii) one or more systemic anomalies determined to meet or exceed the level of importance threshold.

10. The system of claim 1, further comprising:
a second memory;
one or more second computing processor devices in communication with the second memory; and
a resource event tracing sub-system that is stored in the second memory, executable by at least one of the one or more second computing processor devices and configured to, for each resource event occurring within an enterprise:
in response to initiating a resource event, assign a unique identifier to the resource event,
in response to processing the resource event to completion via a plurality of resource event-related applications, (i) capture and record resource event tracing data at each of the plurality of resource event-related applications, and (ii) associate each recorded resource event tracing data with the unique identifier,
compile the recorded resource event tracing data to form a resource event tracing record for the resource event, and
store the resource event tracing record in a record repository.

11. The system of claim 10, wherein the anomaly detection sub-system is further configured to:
implement the AI including the NLP on the unstructured freeform information to identify at least a resource event type for the resource event, and
identify the resource event by accessing the record repository in the resource event tracing sub-system to identify the first resource event tracing record from amongst a plurality resource event tracing records in the record repository, wherein the first resource event tracing record is associated with the first resource event and identified based at least on the user identifier and the resource event type.

12. A computer-implemented method for detecting anomalies as a result of a resource event incident, the computer-implemented method executed by one or more computing processor devices and comprising:
receiving an incident ticket related to an incident occurring within a first resource event conducted by a user, wherein the incident ticket (i) includes a user identifier associated with the user, and (ii) and unstructured freeform information that describes details of the incident;
implementing Artificial Intelligence (AI) including Natural Language Processing (NLP) on the unstructured freeform information to identify the first resource event associated with the incident;
in response to identifying the first resource event, access a compiled first resource event tracing record associated with the first resource event, the first resource event tracing record comprising machine-generated resource event tracing data collected across a plurality of resource event-related applications and compiled into a consolidated tracing record;
analyzing the compiled first resource event tracing record, including the machine-generated resource event tracing data to determine at least one of (i) one or more isolated anomalies resulting from the first resource event, and (ii) one or more systemic anomalies resulting from other resource events that are similar to the first resource event; and
in response to determining the at least one of (i) one or more isolated anomalies based on analysis of the compiled first resource event tracing record and (ii) one or more systemic anomalies, generating, and initiating electronic communication of, an anomaly report that indicates at least one of (a) at least one of the one or more isolated anomalies and (b) at least one of the one or more systemic anomalies associated with the first resource event.

13. The computer-implemented method of claim 12, wherein analyzing further comprises analyzing the first resource event tracing record associated with the first resource event to identify at least one of (i) error codes and (ii) exception codes that indicate the one or more isolated anomalies resulting from the first resource event.

14. The computer-implemented method of claim 12, wherein analyzing further comprises comparing the first resource event tracing record to at least one other resource event tracing record, each other resource event tracing record associated with a corresponding second resource event, to determine at least one of (i) the one or more isolated anomalies resulting from the first resource event and (ii) the one or more systemic anomalies resulting from
the other resource events that are similar to the first resource event.

15. The computer-implemented method of claim 12, further comprising determining whether each of the at least one of (i) one or more isolated anomalies and (ii) one or more systemic anomalies meet or exceed a level of importance threshold, and wherein generating further comprises generating, and initiating electronic communication of, the anomaly report that indicates the at least one of (i) one or more isolated anomalies and (ii) one or more systemic anomalies determined to meet or exceed the level of importance threshold.

16. The computer-implemented method of claim 15, further comprising ranking the at least one of (i) one or more isolated anomalies and (ii) one or more systemic anomalies based on a probability of causing the incident, and wherein generating further comprises generating, and initiating electronic communication of, the anomaly report that indicates, in ranked order, the at least one of (i) one or more isolated anomalies and (ii) one or more systemic anomalies determined to meet or exceed the level of importance threshold.

17. A computer program product including a non-transitory computer-readable medium, the non-transitory computer-readable medium comprising sets of codes for causing one or more computing devices to:
receive an incident ticket related to an incident occurring within a first resource event conducted by a user, wherein the incident ticket (i) includes a user identifier associated with the user, and (ii) and unstructured freeform information that describes details of the incident,
implement Artificial Intelligence (AI) including Natural Language Processing (NLP) on the unstructured freeform information to identify the first resource event associated with the incident,
in response to identifying the first resource event, access a compiled first resource event tracing record associated with the first resource event, the first resource event tracing record comprising machine-generated resource event tracing data collected across a plurality of resource event-related applications and compiled into a consolidated tracing record;
analyzing the compiled first resource event tracing record, including the machine-generated resource event tracing data determine at least one of (i) one or more isolated anomalies resulting from the first resource event, and (ii) one or more systemic anomalies resulting from other resource events that are similar to the first resource event; and
in response to determining the at least one of (i) one or more isolated anomalies based on analysis of the compiled first resource event tracing record, and (ii) one or more systemic anomalies, generating, and initiating electronic communication of, an anomaly report that indicates at least one of (a) at least one of the one or more isolated anomalies and (b) at least one of the one or more systemic anomalies associated with the first resource event.

18. The computer program product of claim 17, wherein the set of codes for causing the one or more computing devices to analyze are further configured to cause the one or more computing devices to analyze the first resource event tracing record associated with the first resource event to identify at least one of (i) error codes and (ii) exception codes that indicate the one or more isolated anomalies resulting from the first resource event.

19. The computer program product of claim 17, wherein the set of codes for causing the one or more computing devices to analyze are further configured to cause the one or more computing devices to compare the first resource event tracing record to at least one other resource event tracing record, each other resource event tracing record associated with a corresponding second resource event, to determine at least one of (i) the one or more isolated anomalies resulting from the first resource event and (ii) the one or more systemic anomalies resulting from the other resource events that are similar to the first resource event.

20. The computer program product of claim 17, wherein the sets of codes further comprise sets of codes for causing the one or more computing devices to:
rank the at least one of (i) one or more isolated anomalies and (ii) one or more systemic anomalies based on a probability of causing the incident further comprising determining whether each of the at least one of (i) one or more isolated anomalies and (ii) one or more systemic anomalies meet or exceed a level of importance threshold; and
determine whether each of the at least one of (i) one or more isolated anomalies and (ii) one or more systemic anomalies meet or exceed a level of importance threshold, and
wherein the set of codes for causing the one or more computing devices to generate are further configured to cause the one or more computing devices to generate, and initiate electronic communication of, the anomaly report that indicates, in ranked order, the at least one of (i) one or more isolated anomalies and (ii) one or more systemic anomalies determined to meet or exceed the level of importance threshold.
